(19) United States
(12) Patent Application Publication
(10) Pub. No.: US 2022/0189265 A1
(43) Pub. Date: Jun. 16, 2022

(54) CHECKOUT APPARATUS AND NUMBER-OF-COMMODITIES CHECK METHOD

(71) Applicant: TOSHIBA TEC KABUSHIKI KAISHA, Tokyo (JP)

(72) Inventors: Keita Yamazaki, Mishima Shizuoka (JP); Yuishi Takeno, Numazu Shizuoka (JP)

(21) Appl. No.: 17/461,514

(22) Filed: Aug. 30, 2021

(30) Foreign Application Priority Data
Dec. 14, 2020 (JP) 2020-206765

(51) Int. Cl. G08B 13/196; G06Q 20/20; G06K 9/00; G06T 7/70; G06K 7/10

(52) U.S. Cl. CPC G08B 13/19613; G08B 13/19691; G06Q 20/208; G06K 9/00355; G06T 2207/30242; G06T 7/70; G06Q 20/203; G06K 7/10386; G06T 2207/30232; G06K 9/00375

(57) ABSTRACT

According to one embodiment, a checkout apparatus includes an interface and a processor. The interface is configured to acquire images from a camera positioned to image an interior opening of a basket. The processor is configured to count the total number of items removed from the basket during a registration of items in a sales transaction based on a detection of the items being removed from the basket in the acquired images from the camera, and then compare the number of items registered in the sales transaction to the total number of items removed from the basket to determine if an unregistered item remains.

### CROSS-REFERENCE TO RELATED APPLICATION

This application is based upon and claims the benefit of priority from Japanese Patent Application No. 2020-206765, filed on Dec. 14, 2020, the entire contents of which are incorporated herein by reference.

### FIELD

Embodiments described herein relate generally to a checkout apparatus and a method for checking the number of commodities registered at a checkout apparatus.

### BACKGROUND

A checkout apparatus is an apparatus that registers information on commodities that a customer is purchasing and performs a payment process to settle the price (total amount due) for the registered commodities. The checkout apparatus needs to perform a registration process for registering information on the commodities to be purchased before the payment process can occur. In the related art, the checkout apparatus reads commodity information as each commodity to be purchased is presented in a reading (scanning) area by an operator's actions. The checkout apparatus then performs the registration process for registering the commodity information of each commodity presented in turn. In such a checkout apparatus, on occasion, some commodity information may not be properly registered by the operator for some commodities, either in error or on purpose.

If the payment process is executed while an unregistered commodity still exists, the checkout apparatus cannot receive request payment corresponding to the prices of all the commodities being removed from the store. In the related art, there is a technique in the checkout apparatus of detecting that an unregistered commodity exists by detecting a suspicious behavior of the operator from a surveillance video. However, it is not easy to reliably detect an unregistered commodity by the behavior of the operator as detected from the surveillance video. In addition, unregistered commodities at the checkout apparatus are not limited to intentional wrongful operation by the operator, and the unregistered commodities may occur unintentionally by the operator. For this reason, there is a demand for a checkout apparatus that can more reliably detect the existence of an unregistered commodity.

### BRIEF DESCRIPTION OF THE DRAWINGS

FIG. 1 is a diagram illustrating a configuration example of a checkout system including a checkout apparatus according to a first embodiment.

FIG. 2 is a block diagram illustrating a configuration example of a checkout apparatus.

FIG. 3 is a flowchart illustrating a registration process and a payment process.

FIG. 4 is a flowchart illustrating a number-of-commodities check process.

FIG. 5 is a diagram illustrating an alert displayed by a display.

FIG. 6 is a flowchart illustrating a hand detection process.

FIG. 7 is a flowchart illustrating a number-of-commodities check process according to a second embodiment.

### DETAILED DESCRIPTION

The present disclosure provides a checkout apparatus and a number-of-commodities check method for detecting the existence of an unregistered commodity at the time of a settlement process or otherwise.

In general, according to one embodiment, a checkout apparatus includes an interface and a processor. The interface is configured to acquire images from a camera positioned to image an interior opening of a basket. The processor is configured to count the total number of items removed from the basket during a registration of items in a sales transaction based on a detection of the items being removed from the basket in the acquired images from the camera, and then compare the number of items registered in the sales transaction to the total number of items removed from the basket to determine if an unregistered item remains.

Hereinafter, certain example embodiments will be described with reference to the drawings.

### First Embodiment

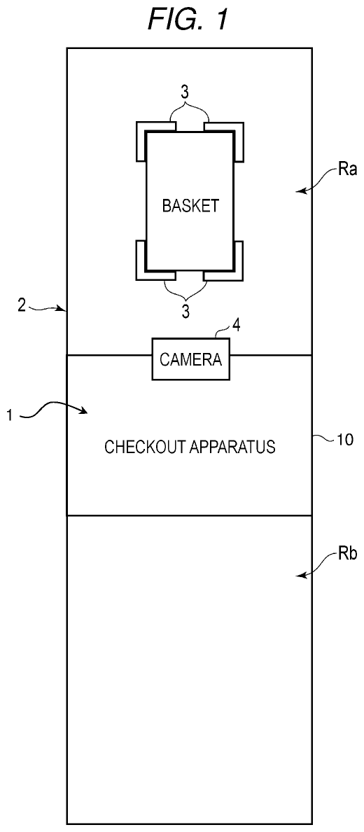

FIG. 1 is a block diagram illustrating a configuration example of a checkout system including a checkout apparatus 1 according to the first embodiment.

In the configuration example illustrated in FIG. 1, the checkout apparatus 1 executes a registration process for registering information about commodities to be purchased by a customer and also a payment process for settling prices of the commodities to be purchased. In the following description, it is assumed that the checkout apparatus 1 executes both the registration process and the payment process as the checkout process. However, in other examples, the checkout apparatus 1 may perform the registration process and then transmit the result of the registration process to an apparatus that performs the payment process.

The checkout apparatus 1 executes the registration process and the payment process for the commodities to be purchased by the customer in response to the operator's actions and instructions. In the checkout apparatus 1, the operator who performs the operations for the registration process and the payment process may be the customer or a staff member such as a clerk. That is, the checkout apparatus 1 may be a self-service checkout apparatus (self-service registration apparatus) that performs the registration process and a payment process for the commodities to be purchased by customer's own operations. In addition, the checkout apparatus 1 may be an apparatus that performs the registration process and the payment process for the commodities to be purchased by the operation of the staff member such as a clerk.

A workbench 2 is for arranging commodities and the like associated with the registration process and the payment process in the checkout apparatus 1. The workbench 2 has a first commodity region Ra in which the commodities are arranged before the registration process and a second commodity region Rb on which the commodities are arranged after the registration process. In the configuration example illustrated in FIG. 1, the first commodity region Ra and the second commodity region Rb are provided on different sides of the checkout apparatus 1. The first commodity region Ra is a commodity mounting place on which the unregistered commodities are to be placed. The registered commodities are placed on the second commodity mounting stand 12 after the registration process.

In the first embodiment, fixtures 3 are installed in the first commodity region Ra. The fixtures 3 hold a shopping basket (hereinafter, also simply referred to as a basket) at a predetermined position. The arrangement, number, type, and the like of fixtures 3 is not particularly limited so long as the fixtures 3 are able to collectively position/hold the basket at a predetermined position.

A camera 4 captures an image for monitoring the operations and the like of the operator of the checkout apparatus 1. The camera 4 can be connected to the checkout apparatus 1. The camera 4 supplies the captured image to the checkout apparatus 1. In the first embodiment, the camera 4 is installed so as to image the basket held by the fixtures 3 in the first commodity region Ra at predetermined position. In addition, the camera 4 images the interior opening of the basket from above.

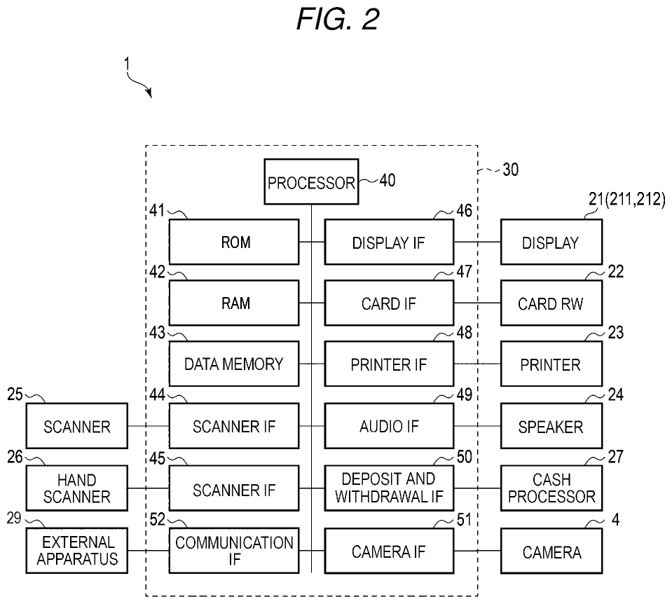

FIG. 2 is a block diagram illustrating a configuration example of the checkout apparatus 1 according to the first embodiment.

The checkout apparatus 1 illustrated in FIG. 2 has a main body 10 that accommodates a control unit 30. The control unit 30 accommodated is implemented as a computer, for example. A display 21, a card reader and writer (RW) 22, a printer 23, a speaker 24, a scanner 25, a hand scanner 26, and a cash processor 27 are provided in the main body 10. Furthermore, the camera 4 is connected to the main body 10.

The display 21 is a touch panel including a display device 211 and a touch sensor 212. The display device 211 displays an operation guide, a customer-selectable icon (touch key), a warning message as an alert, and the like. The display device 211 is, for example, a liquid crystal display (LCD). The touch sensor 212 detects a person's touch position on the display screen (operation screen) of the display device 211. The touch sensor 212 transmits information indicating the detected touch position to a processor or a processing unit.

For example, the display device 211 displays a graphical user interface (GUI) for permitting a user to input selection instructions such as choosing a payment method (cash, card) and/or various other information by a customer's touch operation. In addition, the display device 211 displays a guidance screen, an information input screen, a commodity registration screen, a calculation screen, and the like. The guidance screen is a screen for displaying guidance (message to a user/operator) for informing the customer of the correct operation method. The information input screen is, for example, an operation screen for inputting information about commodities (items) to which barcodes are not attached. The commodity registration screen is a screen for displaying information about the registered commodity. On the commodity registration screen, for example, information about commodities identified by the barcodes (as read by the scanner 25 or the hand scanner 26), commodities manually designated by key operation, or the like can be displayed. The calculation screen is a screen that displays the total amount due for the purchased commodities (registered commodities), the deposit amount, the change amount due, and the like for the payment process during which the customer pays the prices for the registered commodities.

The card reader and writer 22 (“card R-W 22”) processes the card. The card R-W 22 has a card insertion slot. The card R-W 22 has a function of reading data recorded on the card and a can also have a function of writing data to the card. The card read by the card R-W 22 may be a magnetic card reader that also records magnetic information or may be a contact type IC card reader or non-contact type IC card reader. In addition, the card R-W 22 may have of the capability to process a plurality of types of cards.

For example, the card R-W 22 processes a card such as a credit card for payment (settlement) purposes or a membership card for participating in a customer loyalty program or the like. The card R-W 22 reads a card inserted into a card insertion slot or the like. As a card presented for settlement purposes, there is a credit card, a debit card, an electronic money card, a prepaid card (gift card), and the like. In addition, as a membership card, there can be a member's card that records member information or a points card that records points that can be used for various benefits, and the like.

The printer 23 prints a receipt. The printer 23 has a receipt issuing port. The printer 23 dispenses the receipt by printing various character strings, images, and the like on a receipt paper. The printer 23 can be a thermal printer, a dot impact printer, or the like. For example, when the payment process is completed, the printer 23 generates a receipt on which transaction processing content (e.g., payment information) is printed and ejects the generated receipt from a receipt issuing port.

The speaker 24 outputs a sound such as an alert warning sound or a voice as a message.

The scanner 25 and the hand scanner 26 read information that identifies the commodities being purchased. In the present embodiment, it is assumed that the scanner 25 and the hand scanner 26 read a barcode attached to each commodity as the information for identifying the commodity. The scanner 25 optically reads the image of the barcode of the commodity held by the customer so that the barcode attached to the commodity faces the scanner 25. The hand scanner 26 is hand-held and can be operated by the customer to optically read the image of a barcode by being brought close to the barcode attached to the commodity. It is noted that the scanner 25 and the hand scanner 26 may be any type of product registration device that reads or otherwise acquires information for recognizing a commodity and may be, for example, one that reads information other than by barcode.

The cash processor 27 is a machine that processes cash payments and change making. The cash processor 27 has a bill insertion slot, a bill ejection port, a coin insertion slot, a coin ejection port, and the like. The cash processor 27 processes (identifies and counts) the bills inserted into a bill insertion slot 27a. The cash processor 27 ejects the bills as change from a bill ejection port 27b. The cash processor 27 also receives and processes (identifies and counts) coins inserted into a coin insertion slot 27c. The cash processor 27 ejects the coins as change from a coin ejection port 27d.

The camera 4 can be provided separately from the main body 10 of the checkout apparatus 1 and connected to the control unit 30. However, in some examples, the camera 4 is one of devices constituting a component the checkout apparatus 1 and may be thus provided integrally with the main body 10. The camera 4 captures an image of the first commodity region Ra in which the unregistered commodities are placed.

In the first embodiment, the camera 4 is installed so as to image the interior of the basket (and the commodities therein) from above, when the basket is fixed in position by the fixtures 3. That is, the camera 4 is set to image the entire inside of the basket when placed at the predetermined position as defined by the fixtures 3. The images (video) captured by the camera 4 is supplied to the control unit 30 provided in the main body 10 of the checkout apparatus 1.

In the configuration example illustrated in FIG. 2, the control unit 30 includes a processor 40, a read-only memory (ROM) 41, a random-access memory (RAM) 42, a data memory 43, and various interfaces (IFs) 44 to 52. The display 21, the card reader and writer 22, the printer 23, the speaker 24, the scanner 25, the hand scanner 26, and the cash processor 27 are connected to the control unit 30 via the various interfaces (IFs) 44 to 50.

The processor 40 executes various processes and provides various functions by executing a program. The processor 40 is, for example, a central processing unit (CPU). The program can be stored in the ROM 41 or the data memory 43. For example, the processor 40 executes the registration process for registering commodity information of the commodities in a registration mode by executing a dedicated program for registering the commodities. The processor 40 then executes the payment process for settling the prices of the commodities in a payment mode by executing a dedicated program for the payment process.

In addition, the processor 40 executes a number-of-commodities check process by executing a program for the number-of-commodities check process. In addition, the processor 40 executes a hand detection process by executing a program for the hand detection process. It is noted that, in some examples, the program for the number-of-commodities check process and the program for the hand detection process may be executed by another computer (e.g., an external server or the like) connected to the checkout apparatus 1.

The ROM 41 is a non-volatile memory and stores programs and data. For example, the ROM 41 stores programs such as an operating system, middleware, and applications. In addition, the ROM 41 may store data to be referred to when the processor 40 executes various processes.

The RAM 42 stores data and acts a work area for the processor 40. The RAM 42 is a memory used as a so-called work area. The RAM 42 appropriately stores data that the processor 40 refers to when executing various processes, data that is temporarily used, or the like.

The data memory 43 is a memory for storing data. The data memory 43 is a rewritable non-volatile memory. The data memory 43 is configured with, for example, an electrically erasable programmable read-only memory (EEPROM®), a hard disk drive (HDD), a solid-state drive (SSD), or the like. The data memory 43 stores data used when the processor 40 executes various processes or data generated in a process by the processor 40. In addition, the data memory 43 may store various programs executed by the processor 40. For example, the data memory 43 may store a program for the registration process and a program for the payment process.

In addition, the RAM 42 or the data memory 43 stores information about the commodities (the registered commodities) registered in the registration process. The RAM 42 or the data memory 43 may record, for example, the information about the registered commodities as list-format data (also referred to as a registered commodity list). In addition, the RAM 42 or the data memory 43 stores the captured image captured by the camera 28. The data memory 43 may store, for example, video data obtained by adding a time stamp indicating an imaging time (image acquisition time) to the image captured by the camera 28.

The processor 40 is connected to the scanner 25 via the scanner IF 44. The processor 40 acquires an image (scanned image) that has been acquired by the scanner 25 via the scanner IF 44. In addition, the processor 40 is connected to the hand scanner 26 via the scanner IF 45. The processor 40 acquires an image (scanned image) that has been acquired by the hand scanner 26 via the scanner IF 45. The processor 40 identifies a commodity as indicated by a barcode by decoding the barcode in the scanned image from the scanner 25 or the hand scanner 26.

The processor 40 is connected to the display 21 via the display IF 46. The processor 40 controls display contents displayed by the display device 211 of the display 21 via the display IF 46. In addition, the processor 40 acquires information indicating a touch position detected by the touch sensor 212 of the display 21 via the display IF 46. For example, the processor 40 displays a message on the display 21 as an alert or an indicator for notifying the existence of the still unregistered commodities. In addition, the processor 40 detects the input to each icon (touch key) displayed on the display 21 based on the information indicating the touch position.

The processor 40 is connected to the card R-W 22 via the card IF 47. The processor 40 controls the processing of the card by the card R-W 22 via the card IF 47. For example, the processor 40 executes a credit card calculation process processed by the card R-W 22.

The processor 40 is connected to the printer 23 via the printer IF 48. The processor 40 controls the printer 23 via the printer IF 48. For example, the processor 40 dispenses the receipt illustrating the result of the payment process by the printer 23.

The processor 40 is connected to the speaker 24 via the audio IF 49. The processor 40 controls the sound output from the speaker 24 via the audio IF 49. For example, the processor 40 outputs a sound (e.g., a buzzer) via the speaker 24 as an alert for indicating the existence of the still unregistered commodities.

The processor 40 is connected to the cash processor 27 via the deposit and withdrawal IF 50. The processor 40 controls the cash processor 27 via the deposit and withdrawal IF 50. For example, the processor 40 counts the cash deposited by the customer using the cash processor 27 and acquires information indicating the deposit amount counted by the cash processor 27. In addition, the processor 40 controls the cash processor 27 to release the change amount due as calculated from the deposited amount and the total amount due (sum of the purchased commodity prices) for the registered commodities.

The processor 40 is connected to the camera 4 via the camera IF 51. The processor 40 acquires a captured image from the camera 4 via the camera IF 51. For example, during the registration process, the processor 40 acquires images of the interior opening of the basket from the camera 4. In addition, during the registration process, the processor 40 acquires captured images continuously (for example, at a predetermined frequency, rate, or fixed interval) from the camera 4.

The processor 40 can be connected to an external apparatus 29 via the communication IF 52. For example, the processor 40 is connected to an attendant terminal that monitors the operating status of the checkout apparatus via the communication IF 52. The processor 40 transmits information indicating an operating status to the attendant terminal via the communication IF 52. For example, the processor 40 may transmit an alert to the attendant terminal if any error in the registration process is detected.

In addition, the processor 40, in some examples, may be connected to an external apparatus, such as a management server or the like, via the communication IF 52. For example, the processor 40 transmits information about each commodity registered in the registration process by the checkout apparatus 1 to the management server via the communication IF 52. In addition, in some examples, the processor 40 may acquire information about the commodity from a store computer (store server) that communicates via the communication IF 52.

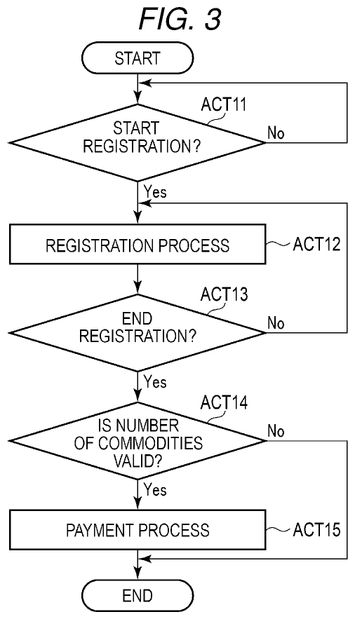

FIG. 3 is a flowchart illustrating an operation example of the checkout process including the registration process and the payment process by the checkout apparatus 1 according to the first embodiment.

First, it is assumed that the customer with the commodities to be purchased stands in front of the checkout apparatus 1. The customer or a staff member then arranges or positions the commodities to be purchased (the unregistered commodities) at a predetermined position. In the first embodiment, the customer or the staff member sets the basket (shopping basket) with the commodities to be purchased therein into the fixtures 3. The fixtures 3 are installed in the first commodity region Ra. Accordingly, the basket (and the unregistered commodities therein) will be at a predetermined position in the first commodity region Ra. The predetermined position for the basket is defined by the placement/arrangement of fixtures 3.

The processor 40 receives an instruction to start the registration process for registering commodity information while in a waiting state (ACT 11). The processor 40 detects the start of the registration process according to an instruction input by the operator (customer or a staff member). Typically, the operator sets the basket in the fixtures 3 and, after that, inputs the instruction to start the registration process for registering the commodity information. For example, the processor 40 detects the start of the registration process by detecting that the operator touched the touch key instructing the start of the registration process displayed on the display 21.

In addition, the processor 40 may detect the start of the registration process by detecting that a basket was set in the fixtures 3. In addition, the processor 40 may recognize the operator's motion from the image captured by the camera 4 and detect the start of the registration process in response to the recognized operator's motion.

When the processor 40 of the checkout apparatus 1 detects the start of the registration process (YES in ACT 11), the processor 40 executes the registration process of registering (inputting) commodity information (for example, information including identification information such as a commodity code) of the commodities to be purchased (ACT 12). In the registration process (a registration mode), the operator holds each commodity picked up from the basket at the reading position of the scanner 25 in turn. The processor 40 reads the commodity information attached to each commodity using the scanner 25. For example, the scanner 25 reads a barcode attached to a commodity. The processor 40 acquires the commodity information as read by the scanner 25. When the processor 40 acquires information from the scanner 25, the processor 40 registers the commodity information.

In addition, in the registration process, the processor 40 may register the commodity information of a commodity as manually designated by the operator using the display 21. For example, the processor 40 registers the commodity information of a commodity according to selections or inputs made by the operator using the touch key(s) displayed on the display 21. In such a case, it is assumed that the operator will generally pick up the commodity from the basket after manually designating the commodity with the touch key(s) or immediately before manually designating the commodity with the touch key(s).

It is noted a commodity registered using the hand scanner 26 may be at a position outside the basket. For example, a large or bulky item may not fit in the basket and thus the checkout apparatus 1 may be used to register such items not placed in the basket. When such an operation occurs, the processor 40 stores (in a memory such as a RAM 42) information particularly indicating the commodities that were registered by using the hand scanner 26. Accordingly, the processor 40 is able to count the number of commodities registered by using the hand scanner 26 and eventually account for such registrations when checking the total number or registered commodities.

During the execution of the registration process, the processor 40 may eventually receive an instruction to end the registration process (or proceed to the payment process) (ACT 13). For example, if the operator (e.g., the customer or a staff member) intends to end the registration process, the operator touches a touch key displayed on the display 21 instructing the end of the registration process (and the proceeding to the payment process). In this case, the processor 40 detects the registration process end by detecting that the operator touched the touch key indicating the end of the registration process displayed on the display 21.

In addition, the processor 40 may detect the end of the registration process by detecting from an image captured by the camera 4 that no commodity still exists in the basket. In addition, the processor 40 may recognize the operator's motion from an image captured by the camera 4 and detect the end of the registration process by recognition of the operator's motion.

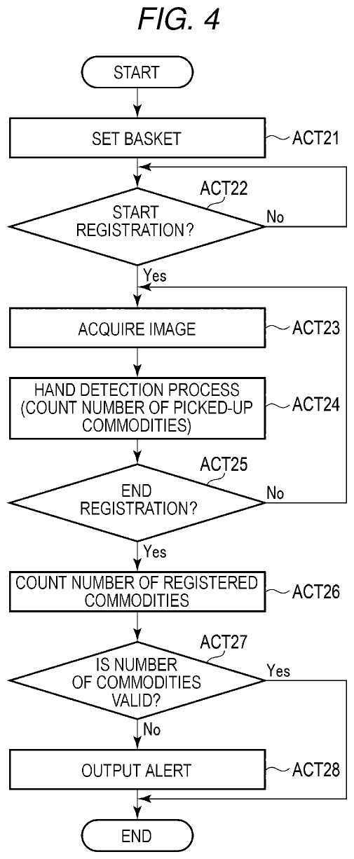

If the end of the registration process is detected (YES in ACT 13), the processor 40 next determines whether or not the total number of commodities registered in the registration process is valid (ACT 14). In this context, validity refers to a matching or agreement between the number of items brough to the checkout apparatus 1 and the number of items actually registered at the checkout apparatus 1. The processor 40 performs the number-of-commodities check process for determining the validity of the number of registered commodities in parallel with the registration process described above. The number-of-commodities check process is executed as the process as illustrated in FIG. 4. The processor 40 determines whether or not the number of commodities is valid based on the result of the number-of-commodities check process.

If it is determined that the number of registered commodities is not valid (NO in ACT 14), the processor 40 stops the checkout process without permitting the proceeding to the payment process. In this case, the processor 40 outputs an alert. For example, the processor 40 displays an alert indicating that an unregistered commodity exists on the display 21. If the alert is output, the processor 40 may restart the checkout process by the confirmation input of the registration contents by the operator, the confirmation input by the observer, additional registration of the commodities (re-registration process), or the like.

If it is determined that the number of registered commodities is valid (YES in ACT 14), the processor 40 proceeds to the payment process. If the processor 40 proceeds to the payment process, the processor 40 executes the payment process for settling the total amount of all the registered commodities (ACT 15). For example, the processor 40 specifies the price of each registered commodity and calculates the total amount due for the commodities. The processor 40 displays the calculated total amount due on the display 21 and performs a process of receiving the payment for total amount due from the customer. Once the payment for the total amount due of the commodities is successfully completed, the processor 40 ends the payment process for the registered commodities.

Next, the number-of-commodities check process in the checkout apparatus 1 according to the first embodiment will be described.

FIG. 4 is a flowchart illustrating an operation example of the number-of-commodities check process in the checkout apparatus 1 according to the first embodiment.

The processor 40 performs the number-of-commodities check process as illustrated in FIG. 4 in parallel with the registration process illustrated in FIG. 3. In number-of-commodities check process, the processor 40 waits for a basket to be set in the fixtures 3 (ACT 21) and also waits for the start of the registration process to be detected (ACT 22).

If the processor 40 detects the start of the registration process (YES in ACT 22), the processor 40 acquires an image captured by the camera 4 via the camera IF 51 (ACT 23). In the first embodiment, the basket set has to be set in a predetermined (as defined by the fixtures 3) in the first commodity region Ra. If each basket used at the store location has a predetermined shape, then position of the interior opening of the basket (image area) in the image captured by the camera 4 is set based on the position of the fixtures 3 and the shape of the basket.

The processor 40 can extract a predetermined area in the image from the camera 4 as an image of the interior opening of the basket.

The processor 40 next executes a hand detection process based on an image from the camera 4. The hand detection process is a process for detecting the entry and exit of the operator's hand from the basket. In this context, a hand is any portion thereof such as a palm with which an grasps and picks up a commodity in the basket. In the hand detection process, the processor 40 detects that the operator picked up a commodity from the basket based on the change of state of the hand with respect to the basket.

In addition, in the hand detection process, the processor 40 performs a process of counting the number of commodities picked up from the basket by the operator. Accordingly, the processor 40 acquires information indicating the number of commodities picked up from the basket as a result of the hand detection process.

During the registration process, the processor 40 detects an instruction to end the registration process (or proceed to the payment process) as described above (ACT 25). The processor 40 repeatedly executes the processes of ACT 23 and ACT 24 until the commodity registration process is ended (NO in ACT 25).

If the end of the registration process is detected (YES in ACT 25), the processor 40 counts up the number of commodities registered in the registration process (ACT 26). For example, the processor 40 operates as a registration number counter that counts the number of registered commodities (number of items registered) and stores the counter number in memory such as the RAM 42. The processor 40 increases (increments) the registration number counter every time commodity information is registered. In this case, the processor 40 can count the number of registered commodities using the value of the registration number counter once the registration process is ended. When the number of registered commodities is counted, the processor 40 next determines whether the number of registered commodities is valid (ACT 27).

For example, the processor 40 determines whether or not the number of registered commodities is valid based on whether the number of registered commodities is equal to the number of commodities that were picked up from the basket as acquired as a result of the hand detection process. Accordingly, the processor 40 can confirm whether all the commodities picked up from the basket have now been registered.

However, since it is assumed that the commodity registered by using the hand scanner 26 may be outside the basket, the processor may further determine whether the number of registered commodities is valid in consideration of the number of commodities that were registered by using the hand scanner 26. For example, the processor 40 counts up the number of commodities registered by using the hand scanner 26. Accordingly, the processor 40 can determine the validity of the total number of registered commodities in further consideration of the number of commodities registered by using the hand scanner 26.

For example, if the number obtained by subtracting the number of commodities registered by using the hand scanner 26 from the total number of registered commodities is equal to the pick-up number (number of items removed from the basket by the operator), the processor 40 can check whether or not the number of registered commodities is valid. This determination is valid if all the commodities registered by using the hand scanner 26 were outside the basket. In addition, if the number obtained by subtracting the number of commodities registered by using the hand scanner 26 from the total number of registrations is equal to or larger than the pick-up number, the processor 40 may determine that the number of registrations is valid. This determination is effective in both the case of an item being registered by using the hand scanner 26 after removal from the basket and the case of the item always being outside the basket.

If it is determined that the number of registered commodities is valid (YES in ACT 27), the processor 40 ends the number-of-commodities check process. According to the operation example illustrated in FIG. 3, after determining that the number of commodities is valid, the processor 40 proceeds to the payment process for settling the price of the registered commodities.

If it is determined that the number of registered commodities is not valid (NO in ACT 27), the processor 40 outputs an alert (ACT 28). For example, the processor 40 displays an alert on the display 21 indicating that the number of commodities registered is not valid (or that an unregistered commodity exists) as an alert output.

In addition, the processor 40 may send an alert that the number of commodities is not valid to the attendant terminal or other external apparatus via the communication IF 52. Accordingly, the attendant terminal for the observer to monitor the status of the checkout apparatus can also send an alert indicating that the number of registered commodities is not valid (or that an unregistered commodity exists).

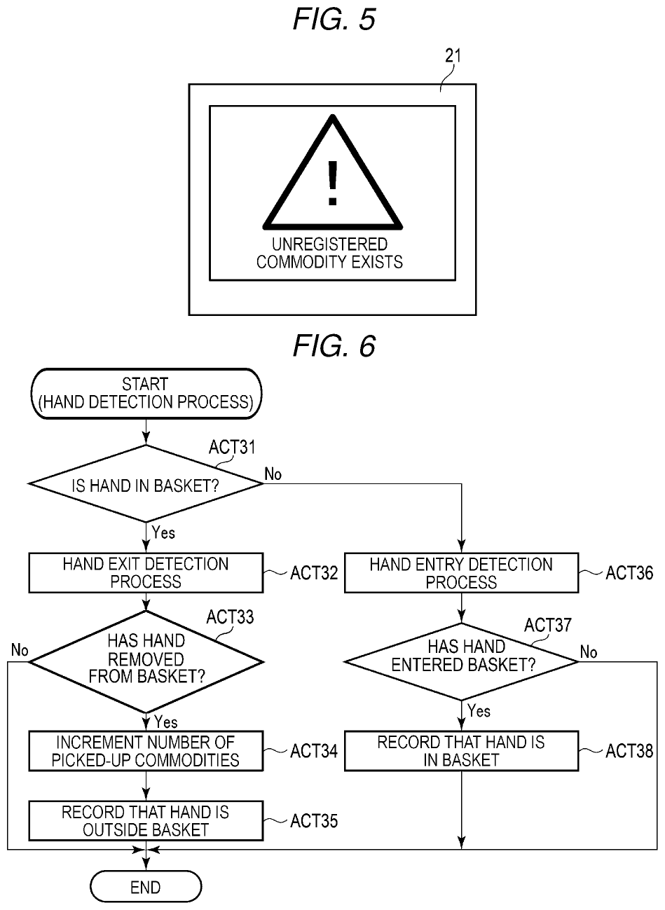

FIG. 5 is a diagram illustrating a display example of the alert displayed on the display 21 of the checkout apparatus 1.

In the example illustrated in FIG. 5, the display 21 displays a guide message or the like on the display 21 indicating that there is still unregistered commodity in response to an alert output instruction from the processor 40. After displaying the alert as illustrated in FIG. 5, the processor 40 may prompt the staff member (observer) to respond or may prompt the operator to confirm the registered commodity. In the former case, the processor 40 may proceed to the payment process after the response by the staff member (staff member's operation). In the latter case, the processor 40 may proceed to the payment process after an instruction is confirmed by the operator or an additional registration of a previously unregistered commodity is performed.

It is noted that processor 40 may send the alert to the mobile terminal possessed by the observer (administrator) as an output of the alert. For example, the processor 40 may send an e-mail containing an alert notification to a predetermined e-mail address (for example, an e-mail address of the observer). Furthermore, the processor 40 may turn on the indicator (warning light) provided to the checkout apparatus 1 to as an alert notification.

Next, the hand detection process in the checkout apparatus 1 according to the first embodiment will be described.

FIG. 6 is a flowchart illustrating an operation example of the hand detection process in the checkout apparatus 1 according to the first embodiment.

First, the processor 40 determines whether or not the position of the operator's hand is in the basket based on the image captured by the camera 4 (ACT 31). The processor 40 stores information indicating the position of the hand in the RAM 42. The processor 40 detects whether the position of the hand is outside the basket or inside the basket by a hand exit detection process or a hand entry detection process. When the registration process is started, the processor 40 detects whether the position of the operator's hand is inside or outside the basket based on the images captured by the camera 4. In addition, once the registration process is started, the processor 40 may assume that the position of the operator's hand is outside the basket as an initial state.

If it is determined that the operator's hand is in the basket (YES in ACT 31), the processor 40 executes the hand exit detection process for detecting that the hand has removed from the basket (ACT 32). The processor 40 detects that the hand has removed from the basket based on the image of the opening of the basket extracted from the image captured by the camera 4. For example, the processor 40 detects that the operator's hand has removed from the basket based on the amount of change in the image of the opening of the basket.

Herein, it is assumed that the processor 40 stores the image of the opening of the basket extracted from the image captured by the camera 4 in the memory such as the RAM 42. In the first embodiment, the basket is set in the fixtures 3. For this reason, the processor 40 can specify the position where the opening of the basket is located as a fixed value based on the position where the fixtures 3 hold the basket. In addition, since the processor 40 can specify the position where the opening of the basket is located as the fixed value, the image of the opening of the basket can be easily extracted from the image captured by the camera 4.

As specific examples of the hand exit detection process, there are the following methods. For example, the processor 40 calculates a displacement vector indicating displacement of a feature point position in the current image with respect to the immediately preceding image for the image of the opening of the basket captured by the camera 4. The processor 40 determines whether or not a norm value of the calculated maximum displacement vector is below a threshold value for the exit detection. The processor 40 detects that the hand has removed from the basket if the norm value of the calculated maximum displacement vector falls below the threshold value for the exit detection.

However, the method of detecting the exit of the hand is not limited to the above-mentioned method. For example, the processor 40 may determine whether or not the maximum amount of change in the pixel value in the image of the opening of the basket captured by the camera 4 in time series is below the threshold value. In this case, if the maximum amount of change in the pixel value in the image of the opening of the basket falls below the threshold value, the processor 40 may detect that the hand has removed from the basket.

If it is detected that the hand has removed from the basket (YES in ACT 33), the processor 40 determines that the operator's hand picked up the commodity from the basket. The processor 40 counts the number of commodities picked up from the basket, that is, called a pick-up number (ACT 34). For example, the processor 40 provides a pick-up number counter for counting the number (pick-up number) of commodities picked up from the basket in the memory such as the RAM 42. The processor 40 increments (adds 1) the pick-up number by counting up the pick-up number counter each time the processor detects that the hand has removed from the basket.

If it is detected that the hand has removed from the basket (YES in ACT 33), the processor 40 records information indicating that the operator's hand is outside the basket in the memory such as a RAM 42.

If it cannot be detected that the hand has removed from the basket (NO in ACT 33), the processor 40 ends the hand detection process while assuming that the position of the operator's hand with respect to the basket does not change.

In addition, if it is determined that the operator's hand is outside the basket (NO in ACT 31), the processor 40 executes the hand entry detection process for detecting that the hand has entered the basket (ACT 36). The processor 40 detects the entry of the hand based on the image of the opening of the basket extracted from the image captured by the camera 4. For example, the processor 40 detects the entry of the hand based on the amount of change in the image of the opening of the basket extracted from the image captured by the camera 4 stored in the RAM 42 or the like.

For example, the processor 40 calculates a displacement vector indicating displacement of a feature point position in the immediately preceding image and the current image as the amount of change in the image of the opening of the basket. The processor 40 determines whether or not the norm value of the calculated maximum displacement vector exceeds the threshold value for the entry detection. The processor 40 detects that the hand has entered the basket if the norm value of the calculated maximum displacement vector exceeds the threshold value for the entry detection.

However, the method of detecting the entry of the hand is not limited to the above-mentioned method. For example, the processor 40 may determine whether or not the maximum amount of change in the pixel value in the images captured by the camera 4 in time series exceeds a threshold value. In this case, if the maximum amount of change in the pixel value exceeds the threshold value, the processor 40 may detect that the hand has entered the basket.

If it is detected that the hand has entered the basket (YES in ACT 37), the processor 40 records information indicating that the operator's hand is in the basket in the memory such as the RAM 42. If it cannot be detected that the hand has entered the basket (NO in ACT 37), the processor 40 ends the hand detection process while assuming that the position of the operator's hand with respect to the basket does not change.

The processor 40 executes the hand detection process every time the camera 4 acquires another image until the registration process is ended as illustrated in FIG. 6. As a result, the processor 40 can count the number of commodities (pick-up number) picked up (removed) from the basket by the operator during the registration process as a result of the hand detection process.

As described above, the checkout apparatus 1 according to the first embodiment detects, based on the images captured by the camera, that the commodities were picked up from a basket that is at a predetermined position. The checkout apparatus 1 outputs an alert that an unregistered commodity still exists if the number of registered commodities is not valid for the number of commodities picked up from the basket.

Accordingly, the checkout apparatus 1 can detect that at least one commodity picked up from the basket was not correctly registered and can notify that an unregistered commodity still exists or the like.

The checkout apparatus 1 according to the first embodiment acquires the images captured by the camera 4 having an imaging range covering the interior opening of the basket when held at a fixed position by the fixtures 3. The checkout apparatus 1 acquires the images of the interior opening of the basket from the camera 4. Accordingly, the checkout apparatus 1 can reliably acquire an image of the interior opening of the basket and can perform the hand detection process with high accuracy. As a result, the checkout apparatus can accurately count the number of commodities picked up from the basket and can accurately detect unregistered commodities.

### Second Embodiment

It is assumed that a checkout apparatus 1 according to the second embodiment has a similar hardware configuration as the checkout apparatus 1 described in the first embodiment. That is, it is assumed that the checkout apparatus 1 according to the second embodiment has a configuration illustrated in FIG. 2. For this reason, detailed description of the hardware configuration of the checkout apparatus 1 according to the second embodiment will be omitted.

The checkout apparatus 1 according to the second embodiment is different from that of the first embodiment in that the checkout apparatus 1 detects that the unregistered commodities have been picked up from images of the basket or the shopping cart (hereinafter referred to as a cart) which may be placed at any position rather than at a particular position designated by fixtures 3 or the like. That is, the checkout apparatus 1 according to the second embodiment is used for a system in which the position where the basket is to be put or the position where the cart is placed can be any position (within the imaging field of the camera 4). For example, the checkout apparatus 1 according to the second embodiment can be applied to a system having a configuration in which the fixtures 3 are omitted from the configuration example illustrated in FIG. 1.

When the fixtures 3 are omitted, it is assumed that the basket can be placed at any position in the first commodity region Ra. So long as the basket is in the first commodity region Ra, it is assumed that the camera 4 is installed so as to cover the entire first commodity region Ra.

In addition, the checkout apparatus 1 according to the second embodiment can detect when the unregistered commodities in the cart at a predetermined stop position (cart stop position) are picked up. Herein, it is assumed the cart includes a basket unit, similar to the shopping basket, into which the customer places unregistered commodities during shopping. The basket unit of the cart may an integral portion of the cart or may be a detachably mounted (or mountable) shopping basket placed on the cart.

In addition, a cart stop position for arranging (stopping) the cart and the commodities therein before the registration process is provided, for example, within the area included in the first commodity region Ra or an area adjacent to the first commodity region Ra. The checkout apparatus 1 according to the second embodiment starts the registration process when either a basket is placed in the first commodity region or the cart is placed at the predetermined stop position (cart stop position).

The checkout apparatus according to the second embodiment can also check the commodities that are picked up by the operator from the basket unit of the cart that is stopped at the cart stop position. If the commodities picked up from the basket unit of the cart are also to be checked, the camera 4 according to the second embodiment is installed so as to capture images of the interior opening of the basket unit of the cart at the cart stop position. It is noted that, in the following description, the references to the interior opening of the basket also refer to the interior opening of the basket unit of a cart at the cart stop position unless otherwise noted.

Next, the number-of-commodities check process in the checkout apparatus 1 according to the second embodiment will be described.

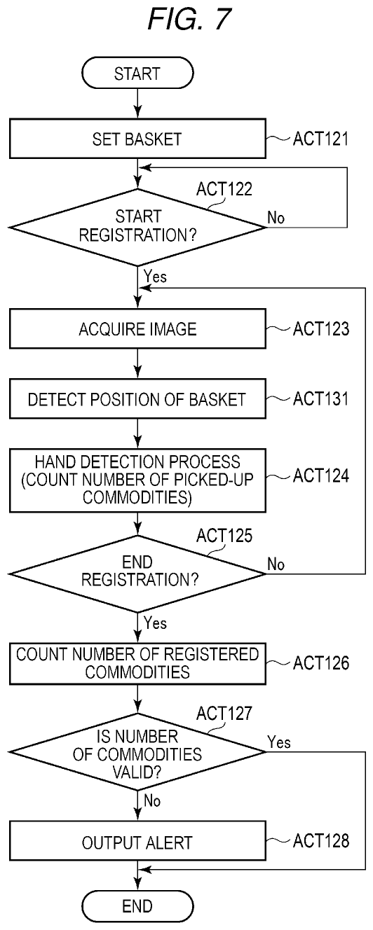

FIG. 7 is a flowchart illustrating an operation example of the number-of-commodities check process in the checkout apparatus 1 according to the second embodiment.

Also in the second embodiment, the processor 40 executes the processing as illustrated in FIG. 3 as described for the first embodiment as the registration process and the payment process. However, in the second embodiment, the processor 40 executes the number-of-commodities check process as illustrated in FIG. 7 (instead of as illustrated in FIG. 4 for the first embodiment) in parallel with the process as illustrated in FIG. 3.

After the basket is mounted in the first commodity region Ra (ACT 121), the processor 40 is in a state of waiting for the start of the registration process (ACT 122). In addition, if processor 40 detects the picking up of a commodity from the cart after the cart is stopped at a predetermined cart stop position, the processor 40 this serves as a start of the registration process. Since processor 40 is able to detect the picking up of a commodity from the cart, it can be assumed that the camera 4 images the interior opening of the basket unit of the cart stopped at the cart stop position.

If the processor 40 detects the start of the registration process (YES in ACT 122), the processor 40 acquires images from the camera 4 via the camera IF 51 (ACT 123). Here, the case of detecting the picking up of a commodity from a shopping basket placed in the first commodity region Ra, will be described. The basket can be placed at any position in the first commodity region Ra. For this reason, the processor 40 must first detect the presence and placement of the basket based on an image captured by the camera 4 (ACT 131).

For example, the processor 40 detects the basket from the pixel values of the pixels constituting the image captured by the camera 4 based on a threshold value set based on the color information for the shopping basket used at the store location. In this case, the processor 40 further identifies the image area including the interior opening of the detected basket. However, the processor 40 is not limited to an image processing technique as described above, and any known image processing technique for object recognition and/or detection may be applied to detect the basket. For example, the processor 40 may detect the basket in an image captured by the camera 4 by using the image processing technique such as template matching.

The processor 40 extracts an image of the opening of the basket from the image captured by the camera 4 in response to the position of the basket being detected. The processor 40 executes the hand detection process based on the extracted images of the interior opening of the basket as captured by the camera 4 and stored in the RAM 42 or the like.

It is noted that the hand detection process is a process for detecting the entry and exit of the operator's hand from the basket, similar in manner to the process described for the first embodiment. For example, the processor 40 executes a hand detection process as illustrated in FIG. 6 and described for the first embodiment. The processor 40 thus acquires information indicating the number of commodities (pick-up number) detected as having been removed from the basket by the operator.

During the registration process, the processor 40 receives an instruction to end the registration process (or proceed to the payment process) (ACT 125). The processor 40 repeatedly executes the processes of ACT 123 and 124 until the commodity registration process is ended (NO in ACT 125).

If the end of the registration process is detected (YES in ACT 125), the processor 40 counts up the number of commodities registered in the registration process (ACT 126). Once the number of registered commodities is counted, the processor 40 next determines whether or not the number of registered commodities is valid (ACT 127).

The processor 40 determines whether or not the number of commodities is valid based on whether or not the total number of registered commodities is equal to the number of commodities picked up from the basket (as acquired as a result of the hand detection process). Accordingly, the processor 40 can confirm by the registered number of commodities whether all the commodities picked up from the basket have been successfully registered.

However, similar to the description of the first embodiment, it may be assumed that in some instances one or more commodities may be registered by using the hand scanner 26 and such items may have always been outside the basket (that is, never picked up and removed from the basket by the operator). In this case, as described in the first embodiment, the processor 40 may determine whether the registered number of commodities is valid in further consideration of the number of commodities registered by using the hand scanner 26.

If it is determined that the number of registered commodities is valid (YES in ACT 127), the processor 40 ends the number-of-commodities check process. According to the operation example illustrated in FIG. 3, after determining that the number of commodities is valid, the processor 40 proceeds to the payment process for settling the price of the registered commodity.

If it is determined that the number of registered commodities is not valid (NO in ACT 127), the processor 40 outputs an alert (ACT 128). For example, the processor 40 displays an alert indicating that the number of commodities registered on the display 21 is not valid. In addition, the processor 40 may output an alert indicating that the number of commodities is not valid to an attendant terminal or other external apparatus that communicates via the communication IF 52.

In addition, similarly to the description in the first embodiment, the processor 40 may send an alert to the mobile terminal possessed by an observer (administrator) as the output of the alert. For example, the processor 40 may send an e-mail containing an alert notification to a predetermined e-mail address (for example, the e-mail address of the observer). Furthermore, the processor 40 may turn on the indicator (warning light) provided on the checkout apparatus 1 as an alert notification.

As described above, the checkout apparatus 1 according to the second embodiment detects, based on the image captured by camera 4, a basket (or cart) that can be placed at any position within the field of view of the camera. The checkout apparatus 1 extracts the image of the interior opening of the basket from an image captured by the camera 4 based on the detected basket. The checkout apparatus 1 detects that the commodity was picked up based on the image of the interior opening of the basket captured by the camera 4. The checkout apparatus outputs an alert that an unregistered commodity still exists if the number of commodities picked up from the basket is not valid for the number of registered commodities.

Accordingly, the checkout apparatus 1 can detect that the commodity picked up from the basket was not registered correctly, and can notify that an unregistered commodity still exists.

According to the checkout apparatus 1 according to the second embodiment, the basket can be detected from the image captured by the camera 4, and the image of the interior opening of the basket can be extracted from the position of the detected basket. Accordingly, the checkout apparatus 1 according to the second embodiment can acquire the image of the interior opening of the basket even in if the basket is placed at an arbitrary position and can still perform a hand detection process. As a result, the checkout apparatus 1 can accurately count the number of commodities picked up from the basket and can accurately detect the unregistered commodities.

It is noted that the above-described first and second embodiments may be applied to a checkout apparatus specifically dedicated to performing the registration process, that is, one that does not execute or handle the payment process after the registration process is completed. A checkout apparatus dedicated to the registration process may transmit information about the registered commodities to a payment apparatus or a payment system that handles the payment process based on the transmitted information. Even in a checkout apparatus dedicated to the registration process, it is possible to detect that an unregistered commodity exists by executing the number-of-commodities check process including the hand detection process.

Furthermore, in the first and second embodiments, a case where a program for configuring a processor to perform the various described functions is recorded in the checkout apparatus 1 in advance has been described, but the present disclosure is not limited thereto, and such a program (or programs) may be downloaded from a network to the checkout apparatus 1, or provided on a non-transitory, computer-readable recording medium. The recording medium may be in any form as long as the recording medium can be read by the checkout apparatus 1 or otherwise loaded or provided. In addition, the various functions and configurations provided by one or more software programs or the like may be provided in conjunction with an OS (operating system) or the like provided in the checkout apparatus 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout apparatus, comprising:
an interface configured to acquire images from a camera positioned to image an interior opening of a basket; and
a processor configured to:
count the total number of items removed from the basket during a registration of items in a sales transaction based on a detection of the items being removed from the basket in the acquired images from the camera; and
compare the number of items registered in the sales transaction to the total number of items removed from the basket to determine if an unregistered item remains.

2. The checkout apparatus according to claim 1, wherein the processor is configured to:
output an alert if the number of items registered in the sales transaction is less than the number of items removed from the basket.

3. The checkout apparatus according to claim 1, wherein the detection of the items being removed from the basket in the acquired images is based on the detection in the acquired images of an entry of a hand into the basket and an exit of the hand from the basket.

4. The checkout apparatus according to claim 3, wherein
the basket is kept at a specific location by fixtures installed at predetermined positions, and
the processor is configured to extract an image portion including the interior opening of the basket from the acquired images from the camera based on the predetermined positions of the fixtures and then detect the entry and exit of the hand in the extracted image portion.

5. The checkout apparatus according to claim 3, wherein the processor is configured to:
detect a position of the basket in the acquired images from the camera,
extract an image portion including the interior opening of the basket, and
detect the entry and exit of the hand in the image portion.

6. A checkout apparatus, comprising:
a work table including a first region and second region;
a product scanner on the work table between the first and second regions;
a camera positioned to image at least the first region;
an interface connected to the camera and configured to acquire images from the camera; and
a processor configured to:
detect items being removed from a basket placed in the first region during a registration of items in a sales transaction, the detection of items being removed from the basket being based on the acquired images from the camera;
count the total number of items removed from the basket during the registration of items in a sales transaction; and
compare the number of items registered in the sales transaction to the total number of items removed from the basket to determine if an unregistered item remains.

7. The checkout apparatus according to claim 6, wherein the processor is configured to:
output an alert if the number of items registered in the sales transaction is less than the number of items removed from the basket.

8. The checkout apparatus according to claim 7, further comprising:
a warning light, wherein
the output of the alert causes the warning light to turn on or change color.

9. The checkout apparatus according to claim 6, wherein the detection of the items being removed from the basket in the acquired images is based on the detection in the acquired images of an entry of a hand into the basket and an exit of the hand from the basket.

10. The checkout apparatus according to claim 9, further comprising:
fixtures at predetermined positions on the work table in the first region, the fixtures being configured to keep the basket at a specific location within the first region, wherein
the processor is configured to extract an image portion including the interior opening of the basket from the acquired images from the camera based on the specific location of the basket and then detect the entry and exit of the hand in the extracted image portion.

11. The checkout apparatus according to claim 9, wherein the processor is configured to:
detect a position of the basket in the acquired images from the camera,
extract an image portion including the interior opening of the basket, and
detect the entry and exit of the hand in the image portion.

12. The checkout apparatus according to claim 6, further comprising:
fixtures at predetermined positions on the work table in the first region, the fixtures being configured to keep the basket at a specific location within the first region.

13. The checkout apparatus according to claim 6, further comprising:
a hand-held product scanner for registering items in the sales transaction, wherein
the processor is configured to track the total number of items registered with the hand-held product scanner during the sales transaction, and then subtract the total number of items registered with the hand-held product scanner from the total number of items registered in the sales transaction and compare this result to the total number of items removed from the basket to determine if an unregistered item remains.

14. The checkout apparatus according to claim 6, further comprising:
a communication interface for communicating with an external device, wherein
the processor is further configured to:
output the alert via the communication interface to the external device.

15. A method for detecting whether the number of items registered in a sales transaction corresponds to the number of items removed from a shopping basket or a shopping cart, the method comprising:
detecting items being removed from a basket placed in the first region during a registration of items in a sales transaction, the detection of items being removed from the basket being based on the acquired images from a camera positioned to image an interior opening for the basket;
counting the total number of items removed from the basket during the registration of items in a sales transaction;
comparing the number of items registered in the sales transaction to the total number of items removed from the basket to determine if an unregistered item remains; and
outputting an alert if the number of items registered in the sales transaction is less than the number of items removed from the basket, wherein
the detection of the items being removed from the basket in the acquired images is based on the detection in the acquired images of an entry of a hand into the basket and an exit of the hand from the basket.

16. The method according to claim 15, wherein the outputting of the alert causes a warning light on a checkout apparatus at which the registration of items in the sales transaction is being performed to turn on.

17. The method according to claim 15, wherein the outputting of the alert causes a display screen of a checkout apparatus at which the registration of items in the sales to display a warning message.

18. The method according to claim 15, wherein the outputting of the alert causes a warning message to be displayed on an attendant terminal.

19. The method according to claim 15, further comprising:
detecting a position of the basket in the acquired images from the camera,
extracting an image portion including the interior opening of the basket, and
detecting the entry and exit of the hand in the image portion.

20. The method according to claim 15, further comprising:
tracking the total number of items registered with a hand-held product scanner during the sales transaction, and then subtracting the total number of items registered with the hand-held product scanner from the total number of items registered in the sales transaction and compare this result to the total number of items removed from the basket to determine if an unregistered item remains.
